(19) United States
(12) Patent Application Publication
(10) Pub. No.: US 2011/0291882 A1
(43) Pub. Date: Dec. 1, 2011

(54) CO-OPERATIVE GEOLOCATION

(75) Inventors: Brendan Walsh, Carlsbad, CA (US); Sridhar Ramesh, Carlsbad, CA (US); Curtis Ling, Carlsbad, CA (US)

(73) Assignee: MaxLinear, Inc., Carlsbad, CA (US)

(21) Appl. No.: 12/954,603

(22) Filed: Nov. 24, 2010

Related U.S. Application Data
(60) Provisional application No. 61/264,458, filed on Nov. 25, 2009.

(51) Int. Cl. G01S 19/46; G01S 5/02

(52) U.S. Cl. 342/357.29; 342/464

(57) ABSTRACT

A method and apparatus for extending the coverage of geolocation to indoor locations through cooperative geolocation. The method includes establishing an ad-hoc wireless network comprising a plurality of devices including a first device. The method includes receiving, at the first device, position information from the plurality of devices and determining a physical location of the first device based on the received position information. In an embodiment, the position information is transmitted in response to a request by the first device. In an embodiment, the position information may include a time of arrival of the request received by each of the plurality of devices; and the time of arrival may be associated with a GNSS time. In an embodiment, the ad-hoc wireless network may be a Wi-Fi network, which is associated with one of the IEEE 802.11 standards.

### CROSS-REFERENCES TO RELATED APPLICATIONS

The present application claims benefit under 35 USC 119(e) of U.S. provisional application No. 61/264,458, filed Nov. 25, 2009, entitled “Co-Operative Geolocation,” the content of which is incorporated herein by reference in its entirety.

### BACKGROUND OF THE INVENTION

The present invention relates to the field of wireless communication systems, and more particularly, to the geolocation of devices in wireless networks.

Conventional geolocation relies on a network of satellites, or an infrastructure of beacons at known locations. The present invention provides methods and systems for extending the coverage of geolocation to indoor locations through the use of what it is referred to as cooperative geolocation, which allows any wireless device to establish its position with a known level of uncertainty by querying other devices using enhancements to standard protocols. The present invention provides a method and apparatus for determining the geographic location of a device equipped with a wireless receiver, based on location information received from one or more neighboring devices equipped with wireless transmitters.

### DEFINITION

In the following it is understood that:
Geolocation refers to three-dimensional position coordinates, e.g. (x,y,z), of a device, or the act of obtaining those coordinates. Geolocation may optionally include other incidental information such as velocity.
GNSS time refers to time which is referenced to a globally-available standard time such as is provided in GNSS systems like GPS.
Geoinfo broadly refers to geolocation, GNSS time, GNSS data such as satellite information (e.g. ephemeris in the GPS system), and other information pertinent to geolocation.
Location advertisement refers to the transmission of Geoinfo either on some regular basis or in response to a detected query by another device, in conformance with some kind of agreed-upon protocol.
Geoquery refers to a broadcast transmission by a device to solicit Geoinfo that may be available from any device within reception range of the originating device.

### BRIEF SUMMARY OF THE INVENTION

Embodiments of the present invention advantageously provide methods and systems for determining a geolocation of devices in wireless communication networks.

In an embodiment of the present invention, a method includes establishing an ad-hoc wireless network comprising a plurality of devices including a first device. The method also includes receiving, at the first device, position information from the plurality of devices and determining a physical location of the first device based on the received position information. In an embodiment, the position information is transmitted in response to a request by the first device. In an embodiment, the position information may include a time of arrival of the request received by each of the plurality of devices; and the time of arrival may be associated with a GNSS time. In an embodiment, the ad-hoc wireless network may be a Wi-Fi compliant network, which is associated with one of the IEEE 802.11 standards.

In another embodiment, a method is provided for relaying information in a wireless network having a plurality of hop-devices working in cooperation. The method includes sending information data, which may include a hop indicator field, by a first device. The method further includes receiving the information data by at least one second device that is within a communication range of the first device. The at least one second device updates the hop indicator field and relays the information data with the updated hop indicator field. The method additionally includes receiving the relayed information field by a third device that is outside the communication range of the first device.

In yet another embodiment, a cooperative communication system for communicating information in a multi-hop environment includes a first device that sends information data related to its position, and a second device that receives and relays the position information data. The system further includes a third device that receives the relayed position information data. In an embodiment, the first device may include a GPS receiver that receives a GNSS signal, a digital signal processing module coupled to the GPS receiver and configured to process the GNSS signal to obtain GNSS data, and a wireless transceiver coupled to the digital signal processing module and configured to send the GNSS data. In an embodiment, the wireless transceiver is associated with an IEEE 802.11 standard.

In another embodiment, an ad-hoc wireless network includes a plurality of devices working in cooperation, each of the plurality of devices is operable to communicate with at least a neighboring device. The ad-hoc network further includes a first device configured to send a query and receive information data from the plurality of devices. The first device may determine its physical location based on the received information data. In an embodiment, the information data includes a GNSS time. In another embodiment, the information data include a time of arrival of the query at each of the plurality of devices. The first device may calculate a difference of the time of arrival between any two devices and determine its location by performing a trilateration using the difference in the time of arrival.

In yet another embodiment, a wireless mobile device includes a wireless transceiver module configured to establish an ad-hoc network with a plurality of wireless communication devices, wherein each one of the plurality of wireless communication devices may include a GNSS receiver for receiving GNSS signals from a number of satellites. The plurality of wireless communication devices may send their position data in response to a request by the wireless mobile device.

### BRIEF DESCRIPTION OF THE DRAWINGS

The present invention can be readily understood by considering the following detailed description in conjunction with the accompanying drawings, in which:

FIG. 1 is a block diagram of an exemplary propagation of geoinfo between a number of devices according to an embodiment of the present invention;

FIG. 2A is a block diagram of an illustrative example of reverse trilateration according to an embodiment of the present invention;

FIG. 2B is an exemplary request-response protocol for determining a location according to an embodiment of the present invention;

FIG. 3 is a block diagram of an exemplary device according to an embodiment of the present invention;

FIG. 4 is a simplified block diagram of a conventional infrastructure wireless local area network;

FIG. 5 is a simplified block diagram of a cooperative communication system having at least an ad-hoc wireless network according to an embodiment of the present invention;

FIG. 6 is a simplified block illustrating a protocol stack according to an embodiment of the present invention;

FIG. 7 is an exemplary discovery protocol according to an embodiment of the present invention; and

FIG. 8 is beacon frame according to the IEEE 802.11 standard.

### DETAILED DESCRIPTION OF THE INVENTION PEER-TO-PEER EXCHANGE OF LOCATION INFORMATION

In accordance with embodiments of the present invention, mobile devices may include a set of different geolocation position modules. The best known location devices are the GPS receivers. The utilization of GNSS (Global Navigation Satellite System) seems to be the best solution outdoors, but its limit becomes evident in urban canyons and especially in indoors environment, where there is no line-of-sight contact with the satellites. According to embodiments of the present invention, devices may co-operate with one another for location determination. To achieve this, a protocol is implemented to enable devices to exchange location information with peers, i.e., to enable peer-to-peer exchange Geoinfo without requiring an access point or base station.

In traditional wireless local area networks (LANs) or wide area networks (WANs), terminal devices are required to be associated with an infrastructure-based access point or base station to receive networked services. In accordance with embodiments of the present invention, association to an access point is not required. Terminal devices communicate and exchange location information in a peer-to-peer manner using location advertisements, or by responding voluntarily to requests for such information. Unassociated devices are able to hear each other's transmissions such as association requests and beacons. By embedding location advertisements within these messages, these devices allow other devices in the vicinity to determine their own location to within a relatively small region of uncertainty. Specific information fields in a data or beacon frame can be used to embed location information. These include vendor specific reserved fields in the beacon frames and association request frames. Information such as transmit power, received signal strength, and antenna directionality can also be embedded and used to further refine the reliability of this information.

Peer-to-Peer Exchange of Additional Geoinfo

In another embodiment, devices may exchange a more complete set of geoinfo including location as well as accurate timing and satellite information for the purposes of acting as an ad-hoc positioning beacon or enhancing acquisition and tracking of GNSS-based signals for geolocation.

Messages may, for example, embed precise time associated with the beginning or ending of a beacon frame. In an exemplary embodiment, the beacon frame of the IEEE 802.11 standard includes a timestamp indicating the time the frame was transmitted. The timestamp indicates the value of the transmitter's synchronization timer and enables a receiver of the beacon frame to synchronize its local synchronization timer to the beacon frame transmitter. Messages may embed information that relates this timestamp to precise GNSS time. They may also embed GNSS information such as the ephemeris and satellite-specific information in the GPS system. Availability of very accurate timing allows devices to improve their sensitivity to GNSS signals as well as determine the distance or even location of other devices and, with a sufficient number of cooperating devices, perform precise trilateration without relying on GNSS signals. For example, if a receiver knows the precise absolute GNSS time of transmissionbeacon frames as well as the locations of the transmitters of these frames, it can then determine the difference in time of flight of a subset of those beacon frames, and perform trilateration to estimate its own location. Devices may thus use an arbitrary combination of cooperative signals and/or available GNSS signals to establish location with progressive degrees of certainty depending on the number and quality of signals available to them.

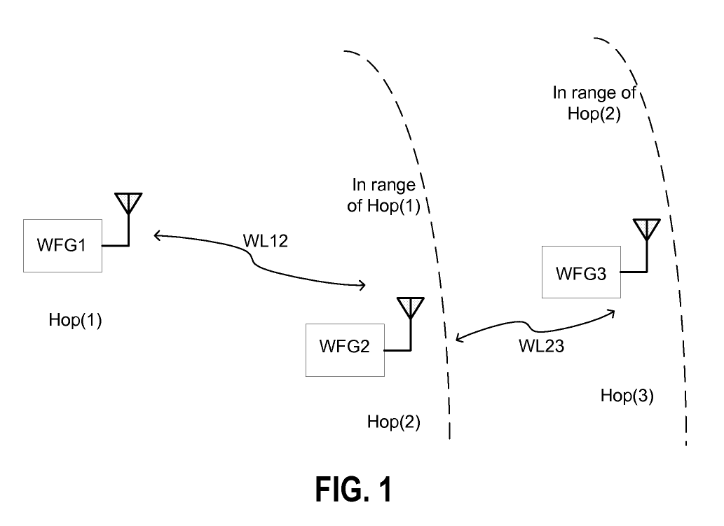

FIG. 1 shows an exemplary propagation of Geoinfo between a number of devices according to an embodiment of the present invention. The number of devices may cooperate in communicating a geoinfo to a receiving device or several receiving devices. This cooperative concept offers several advantages including increased communication range, increased accuracy of the geolocation, and quick acquisition and tracking of GNSS signals for devices that do not have uninterrupted access to GPS satellites signals. In an embodiment, the geoinfo may be routed across multiple hops in networks with no centralized control, i.e., so called ad-hoc networks. An ad-hoc network is a dynamic collection of stationary or non-stationary devices that can communicate with at least one neighboring device without the use of an established infrastructure. The network topology may vary as devices are added, moved, and removed from the network. Thus, ad-hoc networks do not rely on an infrastructure to coordinate routing of messages.

Propagation of Nth-Hand Geoinfo

A device may propagate geoinfo that it receives from other sources in a manner similar to a relay, tracking the number of relay “hops” while also taking precautions to preserve the accuracy of the Geoinfo, e.g., accounting for latency due to processing of packets and retransmission.

Shown in FIG. 1, a message or information data, e.g., a geoinfo, may propagate from a device WFG1 located in Hop(1) to a device WFG2 located in Hop(2), and so on, until it reaches a device WFGi in hop(i). Thus, the message may include the number of hops from the original source of the information. That is, if device WFG1 knows its physical location and/or other geoinfo, it can pass this geoinfo to device WFG2, which may not have any other access to the geoinfo. WFG2 may pass the geoinfo to WFG3 and indicate that it is second-hand information. Likewise, device WFG3 may pass the geoinfo along, indicating that it is third-hand information. This allows for propagation of geoinfo into areas without sources of accurate geoinfo, while tracking the decreasing reliability of that geoinfo. This would, for example, allow WFG3 or any terminal devices in Hop(3) to obtain precise GNSS-time and satellite information without having access to GNSS signals. This is useful for WFG3 to more rapidly acquire and track GNSS signals with its own GNSS receiver system. It also gives WFG3 its own approximate position.

In an embodiment, WFG1 in Hop (1) can be any number of devices that operates in cooperation. In an embodiment, at least one of the devices WFG1 transmits a message or information data according to a protocol (e.g., a collision-avoidance protocol) so that collision can be avoided. WFG2 in Hop(2) is located in a wireless range of WFG1 and receives the message. WFG2 acts as a relay that can further transmit the received message, which will be received by WFG3 in Hop(3). In an embodiment, WFG1 in Hop(1) may include a number of devices that have unobstructed access (e.g., in an open space outside a building) to a GPS signal. Each of the WFG1 devices in Hop (1) will process the GPS signal to obtain individual location information. In an embodiment, the individual location information may contain respective GNSS information data associated with each of the WFG1 devices. Each of the WFG1 devices may transmit the individual location information using a beacon frame that is received by device WFG2, which is within a radio range of WFG1 devices. In an embodiment, device WFG2 may use the multiple received beacons to determine its own physical position. Device WFG2 may indicate increased certainty of its own location if it has a sufficient number of corroborating beacons, even if those beacons are themselves not direct sources of accurate Geoinfo.

In an embodiment, device WFG1 may be fixed access point(s), base station(s) or cell tower(s) with known location that broadcasts a beacon signal via a short-range wireless link (e.g., WL12). Examples of short-range wireless links may include, bur are not limited to, Wi-Fi (IEEE 802.11a/b/g/n) or wireless personal area networks (e.g., IEEE 802.15.4, Bluetooth). Device WFG1 may have line-of-sight contact to some number of satellites and is able to determine its location.

Geolocation by Reverse Trilateration

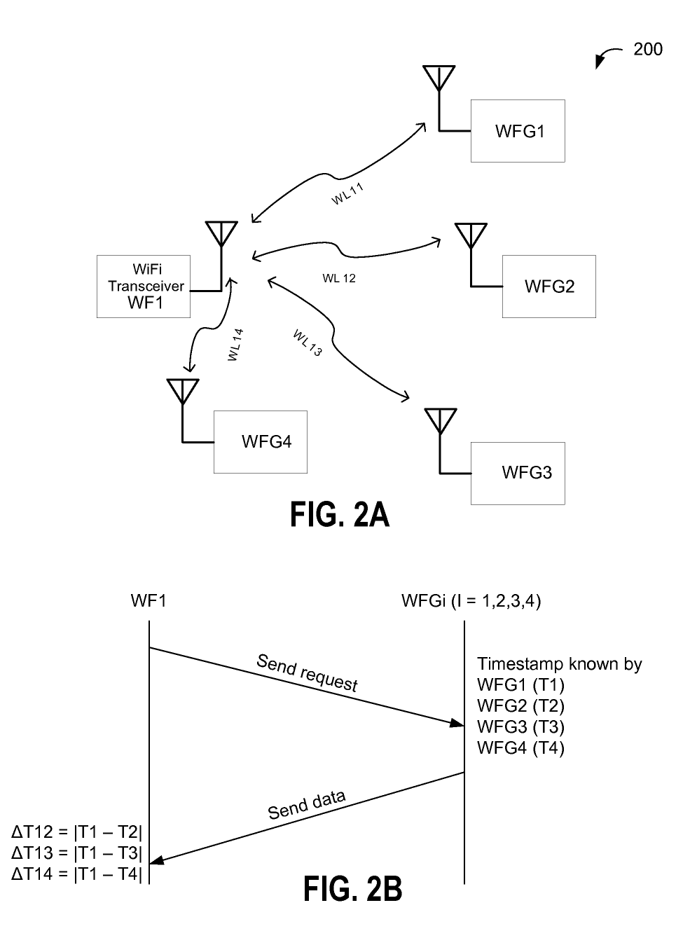

FIG. 2A is a block diagram of an illustrative example 200 of reverse trilateration according to an embodiment of the present invention. In an embodiment, WF1 sends a Geoquery, whose time of arrival is noted by devices WFGi, where index “i” defines an individual device (in the example shown, “i” varies from 1 to 4), which may also have access to GNSS time and an estimate of their own location. Devices WFGi respond back with the GNSS-time of arrival of this particular Geoquery. By noting the differences in times of arrival for each device WFGi, device WF1 can obtain an estimate of its location. As an example, if device WF1 receives two responses from WFG1 and WFG2, WF1 can narrow its location to (in general) two surfaces which satisfy the equation r12−r13=dT where dT is the difference in the GNSS-time reported by WFG1 and WFG2. With four responders WFG1-4, the position and GNSS-time of WF1 may be established using well-known trilateration techniques. So this system implements a portion of the GNSS system working in reverse: receivers WFG1-4 determine the time of arrivals of the Geoquery and transmit this information back to WF1.

Alternatively, in a similar manner, if each WFGi already transmits a beacon frame relating its timestamp to GNSS time (i.e., without a geoquery), WF1 can use the relative difference in time of arrival dT from several WFGi to trilaterate its position without needing to transmit a geoquery.

FIG. 2B is an exemplary request-response protocol for determining a location according to an embodiment of the present invention. Under the assumption that devices WFGi (i=1, 2, 3, 4) are synchronized based on the GNSS clock. As devices WFGi receive the request beacon sent by WF1, a timestamp (the time when the device WFGi receives the request) is captured using the GNSS-based time. Each device WFGi then responds to the request by sending its captured time. Based on the timestamps received from devices WFG1, WF1 can then determine its location using trilateration. In an embodiment, the timestamp may be associated with the beginning of the received beacon frame. In another embodiment, the timestamp may be associated with the ending of the beacon frame. In some embodiments, the response data may include GNSS information such as the ephemeris and satellite-specific information in the GPS system. In another embodiment, without a request beacon from WF1, WFGi automatically attaches information in the beacon frame that associates its timestamp with GNSS time, and attaches its location information as well. By determining the difference in time of arrival of the beacon frames from WFG1, WF1 can trilaterate its position using the known broadcast position of WFGi. In an embodiment, WF1 can be a wireless mobile device that has a narrow view of the sky, which only allows for view of some number of satellites, but not enough to determine a position. In another embodiments, WFGi may be fixed access points or base stations with known location.

Provisions for Privacy and Anonymity

Provisions can be made for anonymous cooperation to reduce concerns about privacy. For example, Geoinfo and peer messaging pertaining to location advertisement can be made to be inaccessible to applications, only to the integrated circuits which use the information to establish location.

Improvements in Coding and Channel Estimation Aids

The protocol used for transmitting Geoinfo can add channel coding, interleaving, redundancy and synchronization aids within its signaling to substantially increase the sensitivity of transceivers sending and receiving beaconing information.

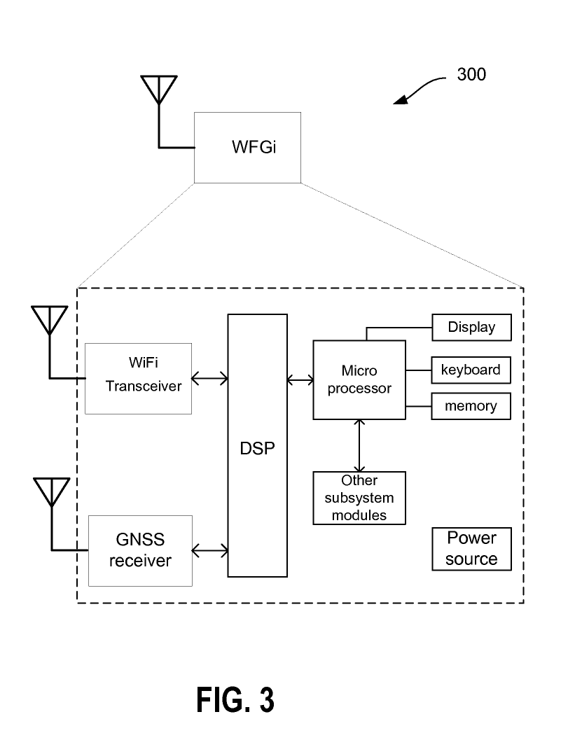

FIG. 3 is a block diagram of an exemplary device WFGi 300 according to an embodiment of the present invention. Device WFGi includes a GNSS receiver for receiving GNSS signals from multiple satellites, a digital signal processing (DSP) unit for processing the received GPS signals to obtain GNSS information data (geoinfo), a Wi-Fi transceiver coupled to the DSP unit for transmitting the geoinfo, a microprocessor connected to the DSP unit for controlling the DSP unit and performing functions of the invention, a memory unit that stores the geoinfo and other control instruction codes and data associated with the invention, a keyboard and a display for user interface. As an alternative, the DSP unit shown in FIG. 3 may include two individual digital signal processing modules, each one is dedicated to the respective GNSS receiver and the Wi-Fi transceiver. Device WFGi 300 further includes a power source that supplies the necessary power for the operation. In an embodiment, device WFGi may deactivate the GNSS receiver when a GNSS signal cannot be detected or the GNSS signal has been degraded to a level that a reliable processing is no longer possible (e.g., indoors). In this case, the microprocessor will configure the device WFGi to track its location using reverse trilateration, as described in above sections and illustrated in FIGS. 2A and 2B.

Authentication of Originating Devices

Information revalidation is necessary to determine authenticity of information and originating devices. When a device receives Geoinfo from multiple sources, it is possible to corroborate information received from one source with that from another source. The “outliers” are thereby identified as unreliable and possibly malicious. The authenticity of the information is used in conjunction with MAC ID (Media Access Control Identifier) and/or other device specific “signatures” to mark rogue devices. When location advertisements are received from multiple devices, the receiving device corroborates the authenticity and reliability of this information.

Devices may implement a “collective wisdom” approach to identify sources of inaccurate or malicious information. One such method to determine reliability is to compute the sample mean and standard deviation of all location co-ordinates received in location advertisements. Co-ordinates lying within a distance (proportional to the sample deviation) from the sample mean are considered reliable. Those lying outside are considered unreliable and discounted. This process may be used recursively to further refine the co-ordinates.

Another method is to use a weighted sample mean. The weights may be assigned, for example, proportional to the strength of the received signal, and inversely proportional to the transmit power, which is also part of the location advertisement. Weights may also account for the trustworthiness of a source. For example, if a device has access to Geoinfo from known, trusted devices, or from its own timing reference which conflicts in some fashion with information from a new device, the new information may be discounted by weighting that new information less.

If the transmitter uses directional transmission, the parameters are included in the location advertisement and are factored into the weight computation by the receiver. Likewise, if the receiver uses directional reception, this is also factored into computation of the weighted sample mean. Protocols may implement a secure credit mechanism to reward and promote co-operative behavior and to punish malicious behavior.

WLAN Implementation

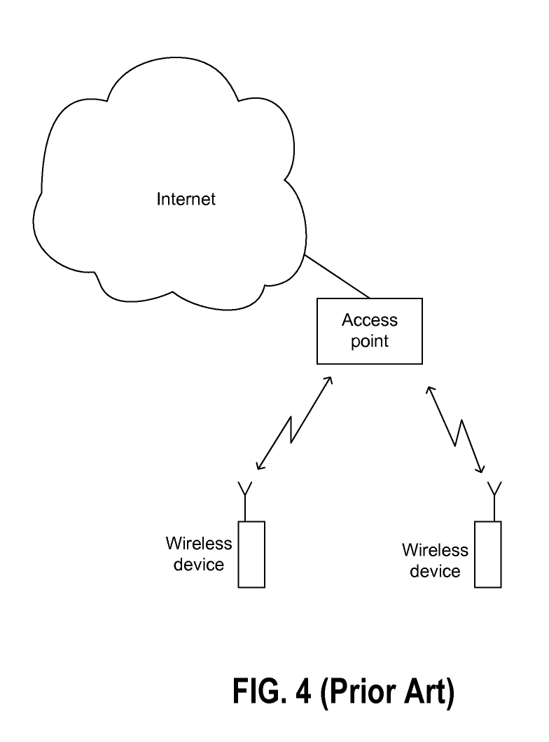

A conventional wireless local area networking (WLAN) system includes at least an access point connected to a backbone network. Non-access point client devices associate with the access point and thereby receive networked services such as Internet access, as shown in FIG. 4. In an infrastructure network, the access point and the wireless devices form a Basic Service Set (BSS). These BSSs can be connected to each other by a Distribution System, which can be a wired network, such as Ethernet LAN. In a BSS, the access point assumes the responsibility to transmit a beacon frame in regular interval to announce the presence of a wireless LAN. A beacon frame is one of the management frames and contains all the information about the network.

In accordance with one embodiment of the present invention, devices do not require association with an access point to determine geographic location. They receive peer to peer messages from other client devices. The devices are able to exchange Geoinfo in a peer-to-peer manner, without requiring association to an access point. This eliminates the need for an access point to be present and to associate the client device. However, the presence of an access point does not hamper the scheme in any way.

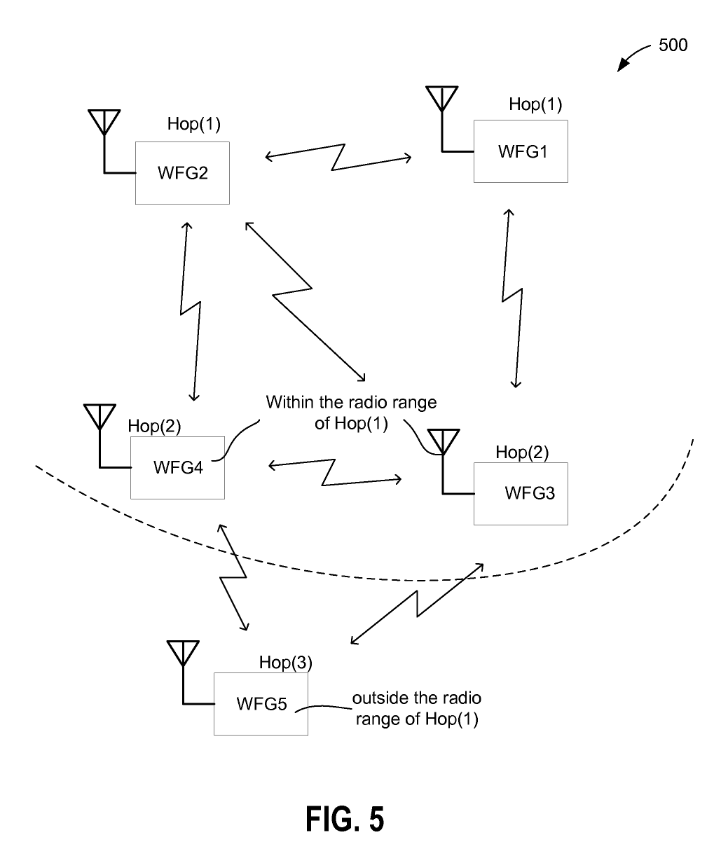

FIG. 5 is a simplified block diagram of a cooperative communication system 500 having at least an ad-hoc wireless network according to an embodiment of the present invention. The independent devices WFGi form an ad-hoc network without the services of an access point. An ad-hoc network is also referred to as a peer-to-peer network or an Independent BSS (IBSS) network. A device can join an ad-hoc network by simply having the same Service Set Identifier (SSID) and the same channel. In an ad-hoc network, one of the devices assumes the responsibility of sending a beacon frame. The sending device sets the beacon interval of the ad-hoc network by initiating a series of Target Beacon Transmission Times (TBTTs). At each TBTT, each device in the ad-hoc network calculates a random time delay and then broadcasts a beacon frame when no other devices are transmitting.

Here, the idea is that individual devices can communicate to other terminal devices through intermediate devices within their radio range using ad-hoc mode of operations. Each device has to manage and maintain known optimal paths, which can change due to the mobility in order to route Geoinfo to the particular device that requests it. Since Geoinfo can be relayed using multi-hop links, a device within a hop without access to GNSS signals can determine its physical location through the information data or Geoinfo from multiple neighboring devices.

Shown in FIG. 5, device WFG5 in Hop(3) may send a query for information data that is received by devices WFG3 and WFG4 in Hop(2). Upon receipt of the query, devices WFG3 and WFG4 send information related their position. In an embodiment, devices WFG3 and WFG4 may be intermediate devices that relay position information sent by devices WFG1 and WFG2 in Hop(1). WFG1 and WFG2 may have access to the GPS signal and have accurate Geoinfo including their location, GNSS time, and other satellite information (e.g., ephemeris in the GPS/GNSS system) and other information pertinent to their location.

Devices can be, for example, laptops, personal digital assistances (PDAs), smart phones, or other handheld devices with an ad-hoc wireless communication interface. Devices can support multiple hop routing in order to forward data packets containing Geoinfo to devices located at the next hop. Data packets may include a hop indicator field that can be updated by devices in intermediate hops to indicated that they are second-, third- or N-hand information. In some embodiments, devices in the intermediate hops may have more than one wireless transceiver module, so that they can maintain communication with the source devices or sending devices and forward (relay) the received data packets to other devices in the next hops using another channel on a different frequency.

Referring to FIG. 5, devices WFG3 and WFG4 in Hop(2) may include two wireless transceiver modules with one configured to communicate with devices WFG1 and WFG2 in Hop(1) on a first channel and another one configured to communicate with device WFG5 in Hop(3) using a second channel that has a different frequency than the first channel. In other embodiments, intermediate devices may have only one wireless transceiver module, so that they store the received data packets from devices WFG1 and WFG2 and relay them late to device WFG5 in Hop(3). In yet other embodiments, intermediate devices may use directional antennas. In any case, the intermediate devices in the multi-hop environment will update the hop indicator field in the data packet to mark that the relayed data packets are second-hand, third-hand, and so forth.

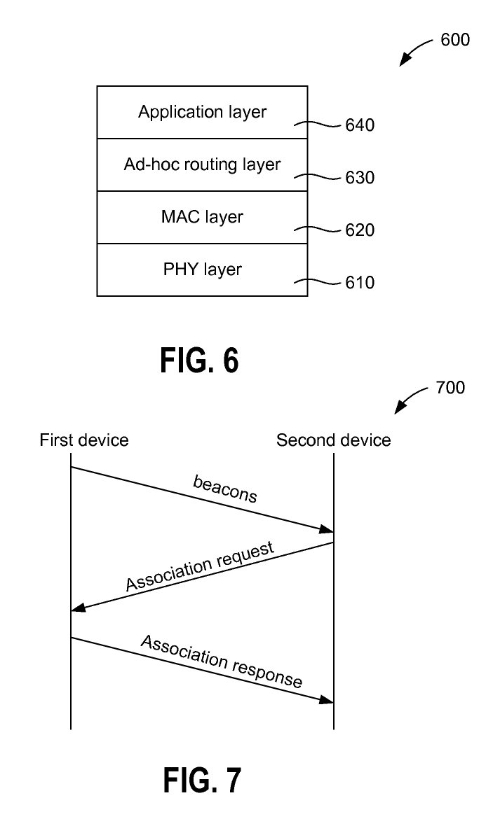

FIG. 6 is a simplified block illustrating a protocol stack 600 according to an embodiment of the present invention. Protocol stack 600 includes a physical (PHY) layer 610 that is the lowest layer of the OSI layer model, a medium access control (MAC) layer 620 that is the second layer of the OSI layer model. The MAC layer supports the discovery and association functionalities, and it also supports the authentication and encryption mechanisms and synchronization of discovered and associated devices. In an embodiment, protocol stack 600 further includes an ad-hoc routing layer 630 that is above the MAC layer. Ad-hoc routing layer 630 may include algorithms or program instruction codes running on a digital processor to update the hop indicator field and to relay received packets to next hops. Protocol stack 600 also includes an application layer 640, which corresponds to the application layer of the OSI layer model. In some embodiments, the PHY and MAC layers may be the IEEE 802.11 standard that divides the PHY layer into two sub-layers, the PLCP (Physical Layer Convergence Protocol) sublayer and the PMD (Physical Medium Dependent) sublayer. The ad-hoc communication method in the IEEE 802.11 MAC protocol is the Distributed Coordination Function (DCF), which is a Carrier Sense Multiple Access with Collision Avoidance (CSMA/CA) MAC protocol. In the DCF, a device, before initiating a transmission, senses the channel to determine whether any other device is transmitting.

FIG. 7 is an exemplary discovery protocol 700 according to an embodiment of the present invention. Discovery protocol 700 uses beacons and associations to support neighbor discovery and determine the logical topology. In an embodiment, the beacons can be application layer packets, so that there is no need to modify any existing MAC and PHY layers of the IEEE 802.11 standard. In an ad-hoc environment, a first or a source device transmits a beacon announcing among other features its SSID and frequency channel, the beacon is received by a second device that is in a radio range of the first device. The second device sends an association request to the first device, which responds with an association response. In an embodiment, the second device may have a second wireless transceiver and advertise its presence to a neighboring hop that is outside the radio range of the first device. The second transceiver may operate the MAC and PHY layers according to the IEEE 802.11 standard, i.e., the second device may also broadcast beacon frames periodically using another frequency channel to establish and maintain communication with other neighboring devices outside the radio range of the first device. The second device may use the ad-hoc routing layer above the MAC layer to buffer and update data packets that are received from the first device and retransmit them using a different channel.

In some embodiments, to communicate with devices not associated with the given device or with an access point, a source device embeds location advertisements inside beacons and association requests. The source device is thus able to announce location information to other neighboring destination devices without requiring association. In a Wi-Fi network, beacon frames have a range of 100 to 200 meters. In an embodiment, the range of the beacon frames can be further extended by using a specific encoding scheme and/or changing transmit power, e.g., using directional antenna.

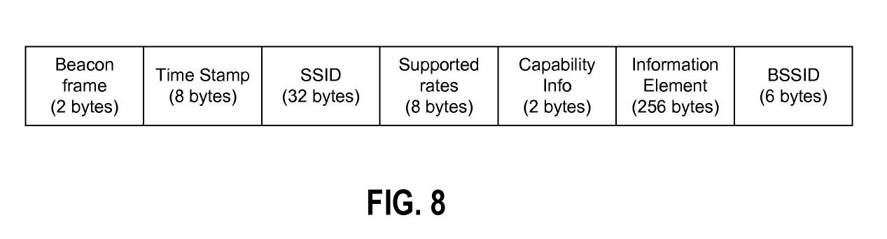

FIG. 8 shows a format of a beacon frame according to the IEEE 802.11 standard. As described in sections above, an ad hoc network may be created by any device without anu pre-planning and for as long as the network is needed for communication. The device creating the ad hoc network determines a service set identifier (SSID), which is an alphanumeric string of 32 bytes, a basic service set identifier (BSSID), and other parameters pertinent for operation of the ad hoc network. The BSSID is a 6-bytes MAC address that identifies a BSS. Devices in the ad hoc network randomly take turn to send beacon frames, which contain the SSID, BSSID, and other information data. In an embodiment, the SSID field, the information element field, and/or the BSSID field can be modified to broadcast the location information. In another embodiment, the vendor specific field may be used for this purpose.

While the advantages and embodiments of the present invention have been depicted and described, there are many more possible embodiments, applications and advantages without deviating from the spirit of the inventive ideas described herein. It will be apparent to those skilled in the art that many modifications and variations in construction and widely differing embodiments and applications of the present invention will suggest themselves without departing from the spirit and scope of the invention. For example, the wireless personal area network (WPAN) specified in IEEE 802.15.4 can be used instead of the WLAN. The WPAN IEEE 802.15.4 also supports a peer-to-peer communication mode; and the data field in the beacon frame can carry location information.

The present invention can be implemented in hardware, software, or a combination thereof. Any computing system or apparatus configured for carrying out the methods claimed herein is suited to perform the functions described herein. While the present invention has been described with reference to particular embodiments thereof, it will be appreciated that in some instances some features of the invention will be employed without a corresponding use of other features without departing from the spirit and scope of the invention set forth in the appended claims.

What is claimed is:

1. A method of determining a geolocation of a device in an ad-hoc communication network having a plurality of devices working in cooperation, the method comprising:
receiving position information from the plurality of devices by a first device; and
determining a physical location of the first device based on the received position information of the plurality of devices.

2. The method of claim 1, wherein the position information is transmitted in response to a request by the first device.

3. The method of claim 2, wherein the transmitted position information comprises a time of arrival of the request received by each of the plurality of devices.

4. The method of claim 3, wherein the determining a physical location comprises:
computing a difference of the time of arrival between any two of the plurality of devices; and
performing a trilateration operation using the difference of the time of arrival between any two of the plurality of devices.

5. The method of claim 3, wherein the time of arrival is associated with a GNSS time.

6. The method of claim 1, wherein the ad-hoc communication network standard is associated with an IEEE 802.11 standard.

7. The method of claim 1 further comprising:
transmitting determined location data by the first device; and
receiving the transmitted the location data by a second device, wherein the second device is within a radio range of the first device.

8. The method of claim 7, further comprising:
relaying the received location data by the second device; and
receiving the relayed location data by a third device,
wherein the third device is outside the radio range of the first device.

9. The method of claim 8, wherein the relaying the received location data comprising:
updating a hop indicator field.

10. The method of claim 1, wherein the receiving position information comprises:
authenticating the position information using a device specific signature.

11. The method of claim 10, where the device specific signature comprises a medium access control (MAC) address.

12. The method of claim 1, wherein the determining a physical location of the first device comprises:
computing a standard deviation of the received position information of the plurality of the devices, wherein the received position information of each one of the plurality of the devices is considered reliable when it is within a predetermined range of the standard deviation.

13. The method of claim 1, wherein the determining a physical position of the first device comprises:
assigning a weight to each one of the received position information of the plurality of the devices, wherein the weight is associated with a received signal strength.

14. The method of claim 1, wherein the position information comprises an indicator field indicating whether the position information is a first-hand or a second-hand information.

15. A cooperative communication system for communicating information in a multiple-hop environment, the system comprising:
a first device sending information data;
at least one second device within a wireless range of the first device receiving the information data and relaying the information data; and
a third device receiving the relayed information data.

16. The cooperative communication system of claim 15, wherein the first device comprises:
a GPS receiver module configured to receive a GPS signal;
a digital signal processing module coupled to the GPS receiver for processing the GPS signal and obtaining GNSS data; and
a wireless transceiver module coupled to the digital signal processing module and being configured to transmit the GNSS data.

17. The cooperative communication system of claim 15, wherein the wireless transceiver module is associated with an IEEE 802.11 standard.

18. The cooperative communication system of claim 15, wherein the information data comprises GNSS data and a hop indicator field.

19. The cooperative communication system of claim 18, wherein the at least one second device updates the hop indicator field of the information data before relaying it further.

20. An ad-hoc wireless network comprising:
a plurality of devices working in cooperation; and
a first device configured to receive information data from the plurality of devices;
wherein a determination of a physical position of the first device is based on the received information data,
wherein the plurality of devices send the information data in response to a request by the first device.

21. The ad-hoc network of claim 20, wherein the first device comprises:
a wireless transceiver module configured to send the query and receive the information data; and
a digital signal processor coupled to the wireless transceiver module and being configured to determine a physical position based on the received information data.

22. The ad-hoc network of claim 20, wherein the information data comprises GNSS data.

23. The ad-hoc network of claim 20, wherein the information data comprises a time of arrival of the query received by each of the plurality of devices.

24. The ad-hoc network of claim 20, wherein the determination of the physical position of the first device comprises:
calculating a difference in the time of arrival between any two of the plurality of devices; and
performing a trilateration operation using the difference in the time of arrival.

25. A wireless mobile device comprising:
a wireless transceiver module configured to establish an ad-hoc network with a plurality of wireless communication devices, wherein each of the plurality of wireless communication devices includes a global navigation satellite system (GNSS) receiver configured to receive signals from at least one satellite.

26. The wireless mobile device of claim 25, wherein the plurality of wireless communication devices are configured to send position information in response to a request by the wireless communication module.

27. The wireless mobile device of claim 26, wherein the sent position information is associated with a GNSS signal.

28. The wireless mobile device of claim 25 further comprises a processor configured to determine a position of the wireless mobile device based on the sent position information by the plurality of wireless communication devices.
